(19) United States
(12) Patent Application Publication
(10) Pub. No.: US 2009/0046838 A1
(43) Pub. Date: Feb. 19, 2009

(54) System, Method, and Device for Playing Music During Conversation Suspension

(75) Inventor: Markus Mans Folke Andreasson, Lund (SE)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 11/862,447

(22) Filed: Sep. 27, 2007

Related U.S. Application Data
(60) Provisional application No. 60/956,039, filed on Aug. 15, 2007.

(51) Int. Cl. H04M 11/00

(52) U.S. Cl. 379/101.01

(57) ABSTRACT

Methods and apparatus for providing substitute media content to a communications device user during suspension of a communications session is disclosed. In an exemplary method, a communications device suspends output of audio or video information flowing from a remote communications node, in response to a received suspend message. The communications device initiates playback of substitute media content until a resume message is received, whereupon the device suspends playback of the substitute media content and resumes output of audio or video information flowing from the remote communications terminal.

### RELATED APPLICATION

This application claims the benefit of U.S. Provisional Patent Application 60/956,039, filed on Aug. 15, 2007, which is incorporated herein by reference.

### BACKGROUND OF THE INVENTION

The present invention relates generally to communication systems and more particularly to a method for providing substitute media to be played during suspension of a communications session.

Users of communications systems are occasionally placed on hold, whether during a person-to-person telephone call or during a multi-person video conference session. Various systems, particularly for use in commercial contexts, have been developed to provide audio content such as “on-hold” music or commercial advertisements for the waiting caller to hear. Typically, these systems are deployed at one end of a telephone connection, often at a business—after a caller is placed on hold, music or other audio is switched on to the voice channel at the business end.

With these systems, the on-hold party typically has no control over the audio material that is played during the on-hold period, although systems for personalizing on-hold music have been described. One example is provided by U.S. Patent Application Publication No. 2007/0047711, which describes a network-based system for determining that a subscribing user is placed on-hold and sending personalized on-hold music to the user.

Previous approaches to providing customized audio to users during suspension of a communication session have focused on traditional circuit-switched technology, and in particular have relied on in-band transmission of audio to the on-hold user. These approaches have not exploited the increased flexibility and network independence made possible by modern digital communications technologies. Furthermore, these approaches have failed to keep pace with the development of communications modes beyond simple person-to-person voice calls.

### SUMMARY

The present invention provides a method and device for providing substitute media content to a communications device user during suspension of a communications session. In an exemplary method, a communications device suspends output of audio or video information flowing from a remote communications node, in response to a received suspend message. The communications device initiates playback of substitute media content until a resume message is received, whereupon the device suspends playback of the substitute media content and resumes output of audio or video information flowing from the remote communications terminal.

Substitute media content may be retrieved from local memory, or from a remote content server. In one or more embodiments, the communications device sends a content request to a content server, and initiates playback of substitute media received from the content server in response to the request. The content request may include one or more parameters used by the content server to select the substitute media content.

### BRIEF DESCRIPTION OF THE DRAWINGS

FIG. 1 illustrates an exemplary communication network.

FIG. 2 is a flow diagram illustrating an exemplary method for providing substitute media during suspension of a communications session.

FIG. 3 illustrates an exemplary signal flow according to one or more embodiments of the invention.

FIG. 4 illustrates another exemplary signal flow.

FIG. 5 is a block diagram illustrating functional components of an exemplary communications device.

### DETAILED DESCRIPTION

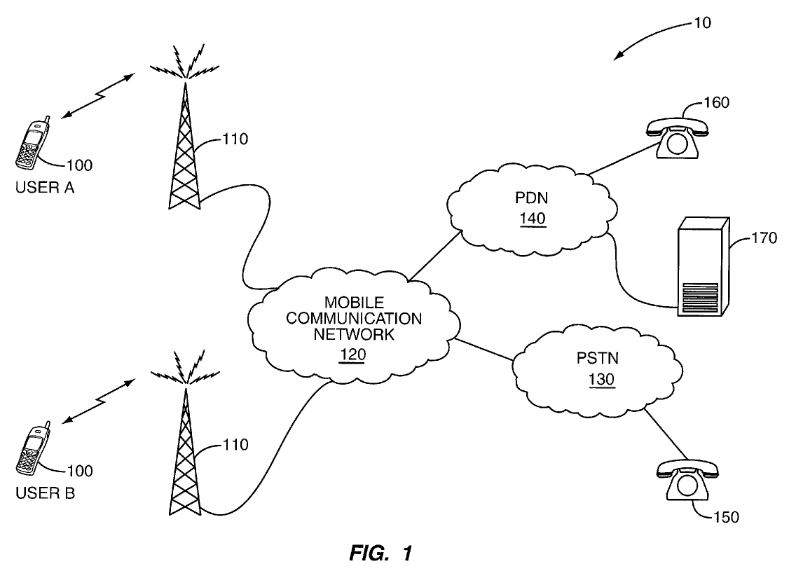

Referring now to the drawings, the present invention will be described in the context of a communication network 10 as shown in FIG. 1. Communication network 10 comprises a mobile communication network 120 having one or more base stations or wireless access points 110 for communicating with mobile terminals 100. Mobile terminals 100 may comprise, for example, cellular telephones, personal digital assistants, laptop computers, or other mobile devices. Mobile communication network 120 connects to the public switched telephone network (PSTN) 130 and to a packet data network (PDN) 140. PSTN 130 is a circuit-switched network providing both voice and data communications, and in particular provides voice service to traditional telephones such as telephone 150. PDN 140 comprises a packet-switched network that implements known protocols, such as conventional Internet protocols, for routing packets of data from one end point to another. PDN 140 may comprise a public or private network, and may be a wide area or local area network. The Internet is one well-known example of a PDN 140. Among the services that may be provided using PDN 140 are packet-switched voice services, such as so-called Voice-over-Internet-Protocol, or VoIP, services. Using VoIP technology, digital devices such as Internet phone 160 may conduct voice calls with other VoIP devices or with traditional phones such as telephone 150.

One or more content servers 170 connect to the packet data network 140. Content servers 170 are accessible to the mobile terminals 100 via the mobile communication network 120 and packet data network 140. Content servers 170 are also available to digital phone 160, as well as to other digital devices (not shown), via PDN 140. The content servers 170 may, for example, comprise web servers, email servers, file servers, or other types of servers.

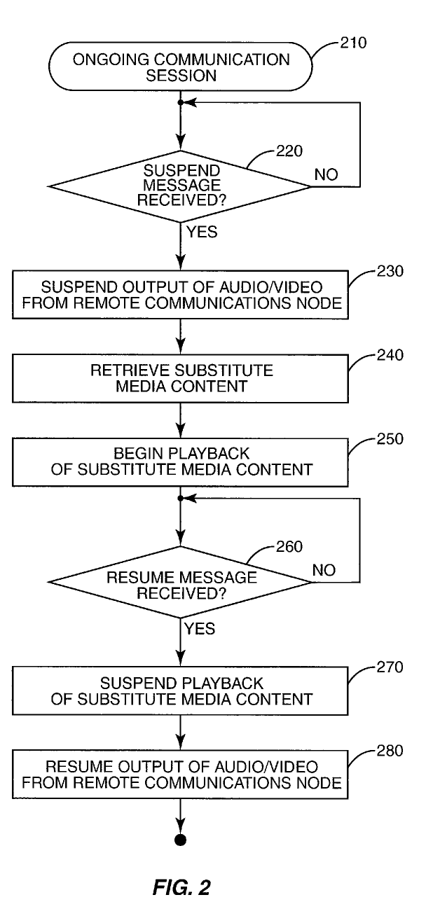

FIG. 2 illustrates a general method for providing substitute media content during suspension of a communications session. Although the method illustrated in FIG. 2 is described below with reference to the system components of FIG. 1, those skilled in the art will recognize that the described method is applicable to a variety of systems and network topologies.

The method of FIG. 2 begins during an ongoing communication session, such as a voice or video call between User A and User B on mobile terminals 100, at block 210. At block 220, one of the mobile terminals 100 checks for the receipt of a message indicating that the other user has suspended the communications session. This message will typically be sent by the remote terminal, but may also be sent by a network component.

The suspend message may be sent by a variety of means. In some embodiments, the suspend message may be sent as part of the call signaling between terminals and fixed network components. In others, the suspend message is sent from one terminal to another according to a communications protocol supported by both end terminals. For example, a VoIP session may be set up using Session Initiation Protocol (SIP) messages; one or more SIP messages may be used to indicate that the communication session is to be temporarily suspended. In general, the suspend message may be sent within the framework of the communication session itself, or through a completely distinct data session. Thus, the methods described herein may be applied by dual-mode communications devices that support, for example, circuit-switched voice calls simultaneously with packet-switched data communications.

Once a suspend message is received at block 220, the receiving mobile terminal 100, or “on-hold” terminal, suspends output of audio and/or video received from the remote terminal 100. In certain cases, the remote terminal 100 may discontinue sending any audio or video, such as by muting the remote terminal's microphone. In this case, a circuit-switched communication channel between the devices may remain active, but be silent. In other cases, the remote terminal 100 or other network component may send on-hold music or other audio or video to the on-hold terminal. In either event, however, the on-hold terminal 100 ignores incoming audio or video information in the sense that neither is routed to an output device of the on-hold terminal 100. The session is not dropped, however. For instance, in a packet-based communication session the on-hold terminal 100 may not receive any audio or video packets during the session suspension; although no audio or video from the session is routed to the output devices, on-hold terminal 100 continues to maintain the packet data session as necessary.

After receiving the suspend message and suspending output of audio or video from the remote terminal, the on-hold terminal 100 retrieves substitute media content at block 240. The substitute media content may be retrieved from a locally stored database, such as a music library stored in terminal's internal flash memory or in a removable memory module installed in the on-hold terminal 100. On-hold terminal 100 may alternatively retrieve the substitute media content from content server 170, via PDN 140. The retrieved media content, which may comprise audio data, video data, or both, is played for the user, i.e. routed to one or more output devices, at block 250. Thus, the user is able to hear or view the substitute media content during the communication session suspension.

Playback of the substitute media content continues until a message is received, at block 260, indicating that the user of the remote terminal 100 has resumed the communication session. Upon receipt of this resume message, playback of the substitute media content is suspended, at block 270, and output of audio and/or video from the remote terminal 100 is resumed at block 280 and the communications session continues.

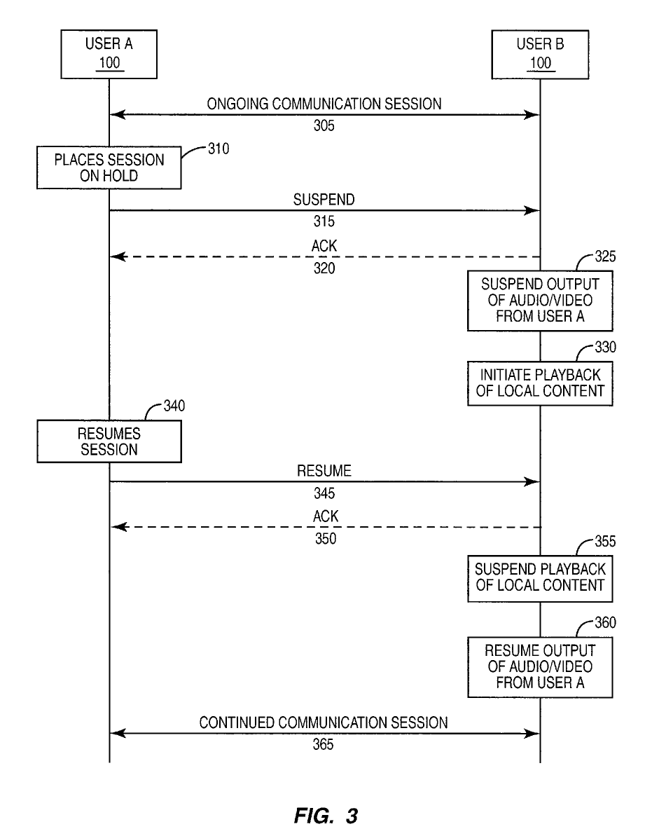

As noted above, the substitute media may be retrieved from local storage, or from a remote database, such as content server 170. FIG. 3 illustrates an exemplary signal flow for the former case. Although the signal flow of FIG. 3 only shows communications between two users, User A and User B, those skilled in the art will recognize that the described signal flow is applicable to multi-party communication sessions in general, including conference calls, video calls or conferences, online “chat” sessions, and the like.

As before, the process begins during an ongoing communication session; two-way communication between User A and User B is depicted at 305. At block 310, User A places the session on hold. This may be done by pressing a dedicated button at mobile terminal 100, or selecting a menu item. In some embodiments, muting the audio input will serve to indicate suspension of a communication session. In others, a user may be required to explicitly indicate that the communication session is to be suspended. In any event, placing the session on hold triggers a “SUSPEND” message at 315, which is sent to User B's mobile terminal 100. Optionally, an acknowledge message is returned to User A mobile terminal 100 at 320.

Upon receipt of the SUSPEND message, User B terminal 100 suspends output of audio and/or video received from User A terminal 100. As noted above, User A terminal 100 may discontinue sending audio or video upon placing the session on hold, but may alternatively send on-hold music or other audio or video. In either event, User B terminal 100 disconnects incoming audio or video, if any, from its output devices, i.e. speakers and displays.

User B terminal 100 then initiates playback of local content at 330. The local content may comprise one or more multimedia files, such as digital audio or digital video files, stored in internal flash memory or disk drive, or on a removable memory module. The multimedia files may be played by a general-purpose or special-purpose media player application, triggered automatically upon receipt of the SUSPEND message. The multimedia files may be organized according to a “playlist” pre-defined for such purpose. In order to ensure that User B hears or views a variety of material, User B terminal 100 may keep track of previously played files or portions of files, so that playback of substitute media content begins with material that has not recently been played. If playback continues for an extensive period, material may be repeated, in a loop or “shuffle” fashion. In the former, material is repeated in the same order as previously played, while in the latter, material is played back in a random or pseudo-random order.

Playback of substitute media content continues until User A resumes the session at 340. Upon pressing a dedicated button or otherwise indicating that the session is to be resumed, a “RESUME” message is triggered, as shown at 345. Optionally, the RESUME message is acknowledged at 350. Upon receipt of the RESUME message, User B terminal 100 suspends playback of local content at block 355, and resumes output of audio and/or video received from User A, at block 360. Thus, the communication session continues at 365.

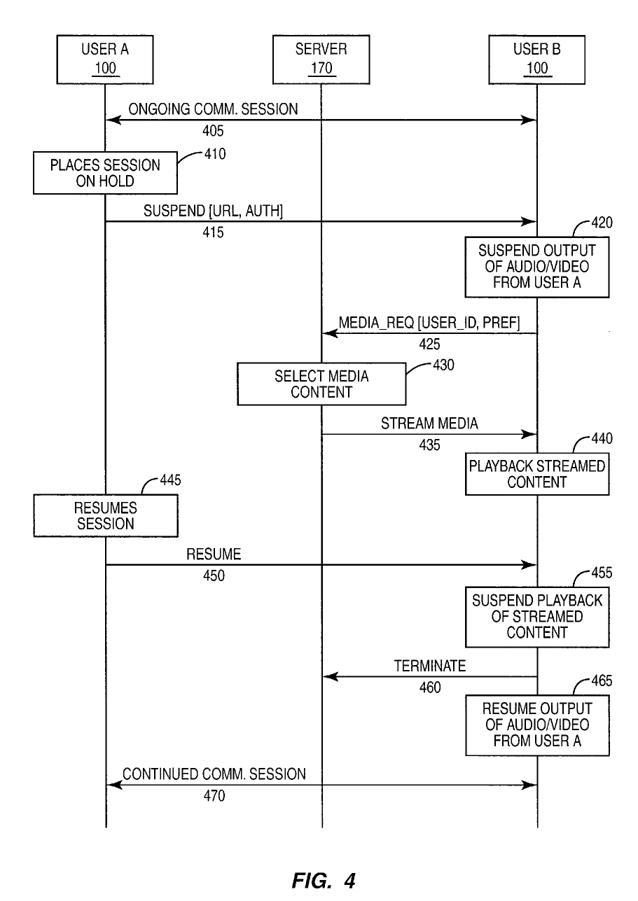

In the scenario described above, substitute media content is retrieved from local storage, and the selection of the substitute media is controlled by the on-hold terminal 100. Alternatively, media may be retrieved from a remote server, such as content server 170. Furthermore, the source of the substitute media content, as well as the selection of the substitute media, may be controlled by the remote terminal 100. A signal flow illustrating these features is given in FIG. 4.

As with the previously described scenario, the process begins with an ongoing communication session between User A and User B, at 405. User A places the session on hold at 410, which triggers a “SUSPEND” message at 415. In the embodiment of FIG. 4, the SUSPEND message includes at least two parameters: a Uniform Resource Locator (URL) and an authorization key. In practice, any network address may be used, although a URL formed in accordance with widely used Internet protocols provides a particularly convenient method for addressing network resources.

At block 420, User B terminal 100 suspends output of audio and/or video received from User A terminal 100. User B terminal 100 forms a content request message (“MEDIA_REQ”), and sends the message to content server 170 at 425. Typically, the content request is addressed using a URL; this may be a URL provided by User A terminal 100 via the SUSPEND message, or it may be a pre-defined URL stored at User B terminal 100. In some embodiments, access to content server 170 may be restricted, requiring the submission of an authorization code; this may be the code provided in the SUSPEND message or a code otherwise known to User B's terminal. In any event, the content request may include additional parameters, such as a requester ID identifying User B or User B's terminal 100, or one or more parameters indicating user preferences specific to User B or User B's terminal, such as media formats, genres, etc.

Upon receipt of the content request message, content server 170 selects media content. The substitute media content selected by content server 170 may be chosen based on the identity of the requesting user, i.e. User B. For instance, a profile corresponding to User B may already be available to content server 170. Alternatively, the substitute media content may be selected according to one or more user preference parameters included in the content request message. These parameters may indicate a preferred media type or types. For example, these parameters may indicate preferred media formats, such as MP3 audio or MPEG-4 video formats. These preferred media formats may reflect user preferences or may indicate rendering capabilities of the requesting terminal 100. The user preference parameters may also specify preferred genres, such as classical music or popular music videos.

In one or more embodiments, the media request message sent to content server 170 may include a parameter indicating an estimated time for the suspension of the communication session. This parameter may, for instance, have been sent to User B terminal 100 in the SUSPEND message from User A before being forwarded to the content server 170 in the RESUME message. Thus, the substitute media selected by content server 170 may be chosen in view of that time estimate—the duration of the selected video clips or audio tracks may be selected to match the estimated suspension time.

However selected, substitute media content is supplied by content server 170 to User B terminal 100 at 435, and played at block 440. Typically, the substitute media content is streamed to User B terminal 100, using a streaming protocol such as the Real Time Streaming Protocol (RTSP) developed by the Internet Engineering Task Force (IETF). However, in some embodiments entire multimedia files are downloaded in their entirety to User B terminal 100 and played back using a media player application.

Those skilled in the art will appreciate that the format of the substitute media content need not correspond in any way to the media format or formats used in the ongoing communication session. For example, video content may be retrieved and played back during suspension of a voice call. Likewise, audio content may be employed as substitute media content during suspension of a video conference. Audio content may be supplemented with video material, such as a “slide show” (succession of still images) or animated material.

Those skilled in the art will appreciate that content server 170 may be a stand-alone network element connected to the Internet as shown in FIG. 1, but may alternatively be a server application running on virtually any network-connected device. Indeed, User A's terminal 100, which suspends the communication session in the above example, may also include a content server application running alongside User A's communication application. In this case, the URL provided to User B terminal 100 in the SUSPEND message may actually provide an address for accessing the server application resident on User A terminal 100. Thus, User A terminal 100 may provide on-hold music to User B terminal 100 using a data connection completely distinct from the suspended communications session.

In any event, playback of substitute media content continues until the communications session is resumed, as shown at block 445. Depending on the duration of the suspension, this may require that content server 170 select additional material for streaming to User B terminal 100. Content server 170 may be configured to automatically select and stream new material upon exhaustion of the previously selected content. In some embodiments, User B terminal 100 may send follow-up content requests to content server 170, requesting additional or alternative substitute media. In one or more of these embodiments, User B may be presented with a user interface allowing him to select specific multimedia titles or to enter his preferences.

In any event, upon resumption of the communications session by User A, a “RESUME” message is sent from User A terminal 100 to User B terminal 100, at 450. Upon receipt of the RESUME message, User B terminal 100 suspends playback of the substitute multimedia content, at 455. This may require that User B terminal 100 send a “TERMINATE” message to content server 170 indicating that streaming of substitute media should be discontinued. At 465, User B terminal 100 resumes output of audio and/or video information received form User A terminal 100, and the communication session continues at 470.

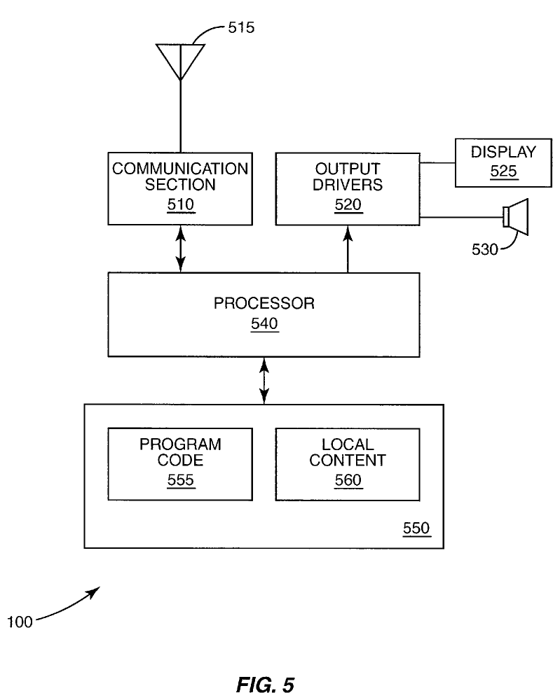

FIG. 5 illustrates an exemplary mobile terminal 100 configured to carry out one or more of the methods described above. Mobile terminal 100 comprises a communication section 510 connected to antenna 515; output drivers 520 connected to display 525 and speaker 530; a processor 540; and memory 550. Processor 540 is responsible for the overall operational control of the mobile terminal 100 according to programs and instructions 555 stored in memory 550. Processor 540 may comprise one or more microprocessors, microcontrollers, hardware circuits, or a combination thereof. Memory 550 stores data, including locally stored multimedia content 560, as well as program code 555 needed for operation of mobile terminal 100. Programs stored in memory 550 may include, for example, an operating system program and one or more application programs, including a media player application configured to produce audio and/or video signals for output drivers 520 from stored or streamed multimedia data. Memory 550 may comprise one or more discrete memory devices, including read-only memory devices, random access memory, flash memory, etc. Memory 550 may further include optical or magnetic storage devices.

Communication section 510 may comprise any known type of wireless transceiver to enable communication with other devices. Communication section 510 may comprise, for example, a cellular transceiver operating according to conventional cellular standards, such as GSM and WCDMA, a WiFi transceiver operating according to the 802.11 family of standards, or a Bluetooth transceiver. Mobile terminal 100 could have multiple transceivers, each operating according to a different communication standard.

The output section of mobile terminal 100 comprises output drivers 520, one or more speakers 530, and one or more video displays 525. Output drivers 520 provide audio and video signals to the speaker 530 and video display 525, respectively. During a communication session with one or more remote terminals, audio and/or video information is received by communication section 510, processed by processor 540, and routed to output drivers 520 for output to speaker 530 and display 525. During suspension of the communication session, processor 540 may retrieve substitute media content from the local content 560 stored in memory 550 and route the corresponding audio and/or video information to output drivers 520. Alternatively, substitute media content may be retrieved from a remote location, using communication section 510.

Accordingly, processor 540 is configured to suspend output at the output section of audio or video information received from a remote communications terminal, in response to a suspend message received during the communications session. This suspend message, routed to processor 540 through communications section 510, may comprise in-band signals transmitted, for example, in the audio path from the remote terminal to mobile terminal 100, or may comprise an out-of-band digital message indicating that communications are to be temporarily suspended. Processor 540 is further configured to initiate playback of substitute media content at the output section, until it receives a resume message. After receipt of the resume message, processor 540 suspends playback of the substitute media content and resumes output of audio or video information flowing from the remote communications terminal.

In some embodiments, processor 540 is configured to generate a content request, and to send the content request to a remote content server 170, using communication section 510. In these embodiments, processor 540 is configured to initiate playback of substitute media content received from the remote content server 170 in response to the content request. As discussed above, the content request may include one or more of: a requester ID identifying the communications device or a user of the communications device; a media type parameter indicating a preferred media type, such as a media format or a genre; and a suspension time estimate. Content server 170 may use one or several of these parameters may to select the substitute media content to be provided to mobile terminal 100. The content request is typically addressed to content server 170 using a URL, which may a pre-defined URL stored in memory 550 or may instead be included in the suspend message received from the remote terminal.

In some embodiments, the suspend message received using communication section 510 may include an authorization key. In these embodiments, processor 540 is configured to include the authorization key in the content request sent to content server 170. The authorization key may be used to authorize access to content that may otherwise be restricted. In some cases, the authorization key may be used by the content server 170 to identify the remote terminal or the remote terminal's user, and may be used to select the substitute media or to bill the remote user for the services provided by the content server 170.

Memory 550 may further contain one or more user-defined settings that control the operation of processor 540 during communication session suspensions. In addition to preferences that indicate, for example, preferred media formats or genres, these user-defined settings may include parameters that indicate whether locally stored or remotely accessed substitute content should be retrieved and played for the user. Thus, even when a URL is provided by the remote terminal in the suspend message, a user-defined setting may cause processor 540 to use locally stored content. Accordingly, processor 540 is configured to selectively, depending on this stored user preference, either initiate playback of locally stored media content or send a content request to content server 170 and initiate playback of media received in response.

Those skilled in the art will appreciate that the functional blocks described above, although described with reference to a wireless mobile terminal, may be implemented in any of a variety of network-connected devices. Thus, other communications devices, such as Internet phones, network-enabled personal digital assistants, portable computers, and the like, may be configured as described to provide substitute media content during a suspended communications session. Indeed, the present invention may be carried out in several other ways than those specifically set forth herein without departing from essential characteristics of the invention. Accordingly, the present embodiments should be considered in all respects as illustrative and not restrictive, and all changes coming within the meaning and equivalency range of the appended claims are intended to be embraced therein.

What is claimed is:

1. A method for providing substitute media content during suspension of a communications session, comprising:
suspending output of audio or video information flowing from a remote communications device, in response to a suspend message;
initiating playback of substitute media content; and
suspending playback of the substitute media content and resuming output of audio or video information flowing from the remote communications device, in response to a resume message.

2. The method of claim 1, wherein initiating playback of substitute media content comprises selecting locally stored media content for the substitute media content and beginning playback of the selected media content using a media player application.

3. The method of claim 1, wherein initiating playback of substitute media content comprises sending a content request to a remote content server and beginning playback of substitute media content received from the remote content server in response to the content request.

4. The method of claim 3, wherein the content request includes a requester ID identifying the requesting communications device or a user of the requesting communications device, for use by the remote content server in selecting the substitute media content.

5. The method of claim 3, wherein the content request includes a media type parameter indicating a preferred media type, for use by the remote content server in selecting the substitute media content.

6. The method of claim 3, wherein the suspend message includes a suspension time estimate, and wherein sending a content request to a remote content server comprises sending the suspension time estimate to the remote content server for use in selecting the substitute media content.

7. The method of claim 3, wherein the suspend message includes a network address, and wherein sending a content request to a remote content server comprises addressing the content request using the network address.

8. The method of claim 7, wherein the network address comprises a Uniform Resource Locator (URL).

9. The method of claim 7, wherein the suspend message further includes an authorization key, and wherein sending a content request for the substitute media content to a remote content server further comprises sending the authorization key to the remote content server for use in authorizing the content request, selecting the substitute media content, or both.

10. The method of claim 1, wherein the suspend message includes a network address, and wherein initiating playback of substitute media content comprises selectively, depending on a stored user preference, either initiating playback of locally stored media content or sending a content request, addressed with the network address, to a remote content server and beginning playback of substitute media content received in response to the content request.

11. A communications device, comprising:
a communications section configured to engage in a communications session with a remote communications node;
an output section; and
a processor connected to the communications section and to the output section and configured to:
suspend output at the output section of audio or video information flowing from the remote communications node, in response to a suspend message received during the communications session;
initiate playback of substitute media content at the output section; and
suspend playback of the substitute media content and resume output of audio or video information flowing from the remote communications node, in response to a resume message.

12. The communications device of claim 11, further comprising a memory unit connected to the processor and configured to store local media content, wherein the processor is configured to select local media content from the memory unit and initiate playback of substitute media content at the output section using the selected local media content.

13. The communications device of claim 11, wherein the processor is further configured to send a content request to a remote content server and to initiate playback of substitute media content received from the remote content server in response to the content request.

14. The communications device of claim 13, wherein the content request includes a requester ID identifying the communications device or a user of the communications device, for use by the remote content server in selecting the substitute media content.

15. The communications device of claim 13, wherein the content request includes a media type parameter indicated a preferred media type, for use by the remote content server in selecting the substitute media content.

16. The communications device of claim 13, wherein the suspend message includes a suspension time estimate, and wherein the processor is further configured to send the suspension time estimate to the remote content server for use in selecting the substitute media content.

17. The communications device of claim 13, wherein the suspend message includes a network address, and wherein the processor is configured to address the content request using the network address.

18. The communications device of claim 17, wherein the suspend message further includes an authorization key, and wherein the processor is further configured to send the authorization key to the remote content server for use in authorizing the content request.

19. The communications device of claim 11, wherein the suspend message includes a network address, and wherein the processor is further configured to selectively, depending on a stored user preference, either initiate playback of locally stored media content or send a content request, addressed with the network address, to a remote media server and initiate playback of substitute media content received in response to the content request.

20. A communications system, comprising:
a first communications device;
a content server; and
a second communications device configured to:
engage in a communications session with the first communications device;
suspend output to a user of audio or video information flowing from the first communications device, in response to a suspend message received during the communications session;
send a content request to the content server;
initiate playback to the user of substitute media received from the content server in response to the content request; and
suspend playback of the substitute media content and resume output of audio or video information flowing from the first communications device in response to a resume message.

21. The communications system of claim 20, wherein the suspend message and resume message are sent by the first communications device to the second communications device.

22. The communications system of claim 20, wherein the content server is configured to select the substitute media content using at least one of a requester ID parameter, media type parameter, suspension time estimate, or authorization key included in the content request.
